(19) United States
(12) Patent Application Publication
(10) Pub. No.: US 2006/0106168 A1
(43) Pub. Date: May 18, 2006

(54) Curable urethane resin composition

(75) Inventors: Tatsuro Ota, Nara-shi (JP); Masatoshi Tanaka, Nara-shi (JP); Osamu Mizobuchi, Nara-shi (JP)

Correspondence Address: OLIFF & BERRIDGE, PLC, P.O. BOX 19928, ALEXANDRIA, VA, 22320, US

(73) Assignee: KYOEISHA CHEMICAL CO., LTD., Osaka (JP)

(21) Appl. No.: 10/535,233

(22) PCT Filed: Nov. 25, 2003
(86) PCT No.: PCT/JP03/14995

§ 371 Date: May 17, 2005

(30) Foreign Application Priority Data
Dec. 2, 2002 (JP) 2002-349785

(51) Int. Cl. C08F 8/30

(52) U.S. Cl. 525/124

(57) ABSTRACT

A curable urethane resin composition comprises a blocked urethane prepolymer which is prepared through condensation-polymerization of a polyol and an organic isocyanate and has a terminal isocyanate group protected by a blocking agent, and a polymer dispersed or dissolved in the blocked urethane prepolymer. The curable urethane resin composition may further comprise a crosslinking agent which performs crosslinking reaction with the terminal isocyanate group of the urethane prepolymer formed through deblocking of the blocked urethane prepolymer to make the prepolymer form a higher molecule while containing the polymer therein.

### TECHNICAL FIELD

The present invention relates to a curable urethane resin composition which is added into a coating material for use, for example, in coating of a base material of a motor vehicle's body, for improving physical properties of the coating material, such as adhesiveness, flexibility, elongation characteristics, etc.

### BACKGROUND ART

A pressed steel plate as the base material of a motor vehicle's body is treated with a sealer such as a sealing paint or a chipping resistant paint to form a base layer on the surface thereof, and then over coating is applied on the base layer.

As the sealer of this kind, a plastisol composition containing polyvinyl chloride resin has been known as shown in Japanese Patent Provisional Publication No. 5-65450. The resulted coated layer has an excellent flexibility, elongation characteristics, tensile strength, flame resistance, adhesiveness, etc. which are peculiar to polyvinyl chloride. However it is feared that polyvinyl chloride might emit toxic substances such as hydrogen chloride, dioxin, etc. when burned.

As a safer sealer that contains no polyvinyl chloride, a composition containing water-based emulsion resins, water-soluble resins, urethane resins or acrylic resins has been studied. But excellent physical properties such as sealability, chipping resistance, adhesiveness, etc. have not so far been given to the coated layers, when compared to polyvinyl chloride resin-containing plastisol composition.

The present invention was made to solve the above mentioned problems. And an object of the present invention is to provide a curable and easy-to-produce urethane resin composition which is used by adding into a sealer, and gives excellent physical properties such as sealability, chipping resistance, flexibility, elongation characteristics, tensile strength, adhesiveness, interfacial failure characteristics, etc. to the coated layer made from the sealer, and to provide a heat-curable plastisol composition containing the curable urethane resin composition which can be usable as a sealer.

### DISCLOSURE OF INVENTION

The curable urethane resin composition aimed at achieving the above mentioned objects of the present invention comprises a blocked urethane prepolymer which is prepared through condensation-polymerization of a polyol and an organic isocyanate and has a terminal isocyanate group protected by a blocking agent, and a polymer dispersed or dissolved in the blocked urethane prepolymer.

Preferably, the curable urethane resin composition contains a crosslinking agent which performs crosslinking reaction with the terminal isocyanate group of the urethane prepolymer formed through deblocking of the blocked urethane prepolymer. The crosslinking agent performs the crosslinking reaction to make the prepolymer form a higher molecule while containing the polymer therein.

The heat-curable plastisol composition for coating of the present invention comprises the curable urethane resin composition and fine powder of an acrylic resin.

When heated, the blocked urethane prepolymer splits thermally into the urethane prepolymer and the blocking agent. The urethane prepolymers crosslink to each other under the presence of the terminal isocyanate groups, polymerizing into a higher molecule to form an urethane network. The polymer is embraced into and contained in the network.

Accordingly, when the coating material containing the heat curable plastisol comprising the urethane resin composition and the fine powder of the acrylic resin is heated, the coating material becomes hard to form a coated layer, while the polymer such as acrylic resin, which is contained in the urethane network, and the fine powder are dissolved, entangled and strongly interacted with each other. As the result, the thus obtained coated layer has an excellent flexibility, elongation characteristics, tensile strength, flame resistance and adhesiveness. Further, the coated layer has an excellent repetitive abrasion resistance. Furthermore, excellent properties of the coated layer can be realized even if considerable amount of the fine powder of the acrylic resin in the plastisol composition is reduced.

### EMBODIMENT OF INVENTION

The curable urethane resin composition of the present invention will be described in detail hereunder.

The resin composition comprises a polymer dispersed or dissolved uniformly in a blocked urethane prepolymer, and a crosslinking agent if necessary.

A blocking agent, which forms the blocked urethane prepolymer, is preferably at least one kind selected from oximes, secondary amines, phenols, alcohols and hydroxyl group-containing (meth)acrylic acid esters. More precisely, as oximes, aldoximes such as acetoxime, ketoximes such as methyl ethyl ketoxime, methyl isobutyl ketoxime, etc. can be exemplified. As secondary amines, secondary alkylamines such as dibutylamine, dicyclohexylamine, diisobutylamine, di-n-octylamine, di-2-ethylhexylamine, etc. can be exemplified. As phenols, alkylphenols, hydroxybenzoic esters, etc. and as alcohols, alkylalcohols can be exemplified. As hydroxyl group-containing (meth)acrylic acid esters, beta-hydroxypropyl (meth)acrylate, beta-hydroxyethyl (meth)acrylate such as LIGHT-ESTER (trade name by Kyoeisha Chemical Co., Ltd.), epoxy esters such as EPOLIGHT (trade name by Kyoeisya Chemical Co., Ltd.) can be exemplified.

The blocking agent is optionally selected in view of the type of organic isocyanates which form the urethane prepolymer, or the temperature of a heat process at the time of forming a coated layer of the plastisol composition for coating containing the curable urethane resin composition. Of which, methyl ethyl ketoxime or dicyclohexylamine is more preferable.

Polyols which form the urethane prepolymer are polyether polyols. As polyether polyols, adducts produced from alkylene oxides having 2 to 6 carbon atoms and low molecular weight compounds having 2 to 5 active hydrogen-containing functional group such as low molecular weight alcohols, low molecular weight amines, phenols, etc. are exemplified.

As such low molecular weight alcohols, ethylene glycol, propylene glycol, diethylene glycol, dipropylene glycol, 1,4-butanediol, 1,6-hexanediol, neopentyl glycol, trimethylolpropane, glycerin, diglycerin, castor oil and derivatives thereof are preferably used. Especially, neopentyl glycol, glycerin and diglycerin are more preferable. As low molecular weight amines, alkanolamines such as monoethanolamine, diethanolamine, triethanolamine, etc.; aliphatic polyamines such as ethylenediamine, diethylenetriamine, triethylenetetramine, etc.; n-alkyl group substituted products of these aliphatic polyamines; allyl group substituted products of these aliphatic polyamines; n-alkyl group substituted products of aromatic polyamines such as tolylenediamine, allyl group substituted products of aromatic polyamines; heterocyclic polyamines such as piperidine, N-aminoethylpiperidine, etc.; alkylene oxide adducts of aliphatic polyamines such as ethylenediamine, diethylenetriamine, triethylenetetramine, etc. are preferable. Especially, adducts produced from one equivalent of aliphatic polyamines to 0.1-16 equivalents of propylene oxide are more preferable. The low molecular weight amines may be used as a mixture thereof. As phenols, catechol, resorcin, hydroquinone and bisphenol are preferable. As alkylene oxides, either one of ethylene oxide, propylene oxide and butylene oxide or a mixture of two or more of them are preferable, and a mixture containing not less than 50% by weight of propylene oxide is more preferable. When the mixture of two or more kinds of alkylene oxides is used, a random- or block-polymerized polyol produced by reacting with low molecular weight compounds such as low molecular weight polyols, etc. is obtained.

Polyols which form the urethane prepolymer may be polyester polyols. As the polyester polyols, polyester polyols prepared through polycondensation reaction using either one of dicarboxylic acid derivatives of dicarboxylic acids, dicarboxylic esters and dicarboxylic halides and low molecular weight polyols such as glycerine, diglycerine, propyleneglicol, etc., preferably glycerine or diglycerine; polyadducts prepared through polyaddition of the dicarboxylic acid derivatives to alkylene oxides; polylactone polyol esters prepared through ring opening polymerization of lactones such as epsilon-caprolactone, delta-valerolactone, etc. and the low molecular weight polyols; are exemplified. As the dicarboxylic acids, aliphatic dicarboxylic acids such as adipic acid, sebacic acid, maleic acid, dimer acid, etc. or acid anhydrides thereof; aromatic dicarboxylic acids such as terephthalic acid, isophthalic acid, etc. or acid anhydrides thereof; are preferably used. Aliphatic dicarboxylic acids are more preferable, and especially adipic acid is still more preferable.

Furthermore, polyols which forms the urethane prepolymer may be vinyl-(meth)acrylic acid ester-copolymerized polyols. As the vinyl-(meth)acrylic acid ester copolymerized-polyols, copolymers, for example, produced from (meth)acrylic acid hydroxy alkyl ester such as beta-hydroxyethyl(meth)acrylate etc. and (meth)acrylic acid derivatives such as (meth)acrylic acid, methyl(meth)acrylate, ethyl(meth)acrylate, butyl (meth)acrylate, isobutyl (meth)acrylate, tert-butyl (meth) acrylate, 2-ethylhexyl(meth)acrylate, etc. and vinyl group-containing compounds can be exemplified.

A mixture of two or more of these polyether polyols, polyester polyols and vinyl-(meth)acrylic acid ester-copolymerized polyols can be used as such polyols.

These polyols preferably have a hydroxyl equivalent of 50-2,000, or an average molecular weight per hydroxyl group obtained by dividing an average molecular weight of the polyol by an average number of hydroxyl groups per molecule. When the hydroxyl equivalent is less than 50, a heat-cured coated layer formed from the plastisol composition containing the fine powder of the acrylic resin added into the curable urethane resin composition loses its flexibility due to an increase of its crystallinity. When the equivalent is more than 2,000, the coated layer becomes considerably deteriorated in its physical strength. Still more preferable, the value of the hydroxyl equivalent is within the range of 100-1,500.

As organic isocyanates which form the urethane prepolymer, at least one kind of monomer selected from aromatic diisocyanates, chain aliphatic diisocyanates and cyclic aliphatic diisocyanates or an oligomer thereof is preferably used.

As aromatic diisocyanates, 2,4′-diphenylmethane diisocyanate, 4,4′-diphenylmethane diisocyanate and mixtures thereof in any mixing ratio; carbodiimide-modified diphenylmethane diisocyanate, polymerized diphenylmethane diisocyanate, urethane-modified diphenylmethane diisocyanate, modified diphenylmethane diisocyanate, 2,4-tolylene diisocyanate, 2,6-tolylene diisocyanate or mixtures thereof in any mixing ratio; xylylene diisocyanate, phenylene diisocyanate, naphthalene diisocyanate, triphenylmethane diisocyanate, toluidine diisocyanate, tetramethyl xylylene diisocyanate, diphenylsulfone diisocyanate, can be exemplified. Of which, tolylene diisocyanate, 2,4′-diphenylmethane diisocyanate, 4,4′-diphenylmethane diisocyanate and carbodiimide-modified diphenylmethane diisocyanate are more preferable. As chain aliphatic diisocyanates, hexamethylene diisocyanate and trimethyl hexamethylene diisocyanate can be exemplified. As cyclic aliphatic diisocyanates, hydrogenated diphenylmethane diisocyanate, isophorone diisocyanate and 3-isocyanatemethyl-3,5,5-triethyl cyclohexylisocyanate can be exemplified. As organic isocyanates, a mixture of two or more monomers of aromatic diisocyanates, chain aliphatic diisocyanates and cyclic aliphatic diisocyanates may be exemplified. As organic isocyanates, any isocyanate selected from aromatic diisocyanates, chain aliphatic diisocyanates and cyclic aliphatic diisocyanates and mixtures thereof in any mixing ratio can be exemplified. As organic isocyanates, oligomers of organic isocyanates such as urethane-modified products, dimers, trimers, carbodiimaide-modified products, alophanate-modified products, urea-modified products, biuret-modified products, etc. may be exemplified.

When preparing the urethane prepolymer through polycondensation reaction of the polyols with the organic isocyanates, it is preferable to use, in a molar ratio, 1.2-2.0 isocyanate group equivalents of the organic isocyanates, preferably 1.5-2.0, with respect to one hydroxyl group equivalent of the polyols. The isocyanate group equivalent or a value obtained by dividing an average molecular weight of the urethane prepolymer by a remaining average number of isocyanate group is preferably within the range of 200-3,000. When the isocyanate equivalent is less than 200, a heat-cured coated layer formed from the plastisol composition containing the fine powder of the acrylic resin added into the curable urethane resin composition becomes hard and brittle. When the isocyanate equivalent is more than 3,000, the coated layer becomes deteriorated in its adhesiveness. More preferable value of the isocyanate equivalent is within the range of 300-1,500. In addition, an NCO % in the urethane prepolymer (a ratio of the molecular weight of —NCO group to a molecular weight of the urethane prepolymer with respect to one —NCO group) is preferably within the range of 1.0-20%, more preferably 2.0-10%.

An average molecular weight of the blocked urethane prepolymer is preferably within the range of 1,000-500,000.

The curable urethane resin composition preferably contains 0.2-60 parts by weight of the polymer with respect to 100 parts by weight of the blocked urethane prepolymer, and more preferably 1.0-20 parts by weight.

Any known resin having various molecular weight and degree of polymerization can be used as the polymer as far as the resin can be dissolved into a solvent, a plasticizer, etc. which is added into the polymer composition or the plastisol composition that contains the polymer composition. The polymer is preferably at least one kind selected from acrylic resins, phenolic resins, epoxy resins, melamine resins, polyester resins, styrene resins, polyethylene resins, polyamide resins and polyurethane resins.

The polymer preferably has the average molecular weight within the range of 200-4,000,000 and a degree of polymerization within the range of 1-40,000, more preferably the average molecular weight is within the range of 3,000-1,000,000.

As the acrylic resins, for example, (meth)acrylic ester copolymers such as methyl (meth) acrylate, ethyl (meth)acrylate, butyl (meth) acrylate, 2-hydroxyethyl (meth) acrylate, 2-hydroxypropyl (meth) acrylate, etc. can be exemplified. As acrylic resins, copolymers of (meth)acrylic acid ester is also exemplified, and more precisely, copolymers of the aforementioned (meth)acrylic acid ester and at least one kind of vinyl group-containing compound selected from unsaturated group-containing carboxylic acids such as (meth)acrylic acid, maleic acid, etc., vinyl esters, vinyl ethers such as vinyl methyl ether, vinyl butyl ether, etc., maleic acid esters such as diethylmaleate, dibutylmaleate, etc., and fumaric acid esters such as diethyl fumaleate, dibuthylfumaleate, etc. are exemplified. The acrylic resins preferably has an average molecular weight of 2,000-4,000,000 and a degree of polymerization of 20-40,000, more preferably 3,000-1,000,000 in the average molecular weight.

As the phenolic resins, novolak type phenol resins which is derived, for example, from phenol, cresol, xylenol, etc. can be exemplified.

As the epoxy resins, ring-closed compounds obtained, for example, through reaction of a phenolic polynuclear compound with epichlorohydrin, more precisely, EPIKOTE (product name by JER), ARALDITE (product name by Ciba-Geigy Japan Ltd.) and EPICLON (product name by DIC), which are available in a series, can be exemplified.

The polymers such as acrylic resins, phenolic resins, epoxy resins, etc. are introduced into the curable urethane resin composition through, for example, synthesizing those polymers in the blocked urethane prepolymer. Another method may be that the polymer is synthesized in advance in the polyols, then the urethane prepolymer is synthesized, and then the prepolymer is blocked. Still another method may be that the polymer is added and dissolved at the time of synthesis of the urethane prepolymer, and then blocked.

The urethane prepolymers can act as self-curing type resins which can crosslink by themselves, so that the curable urethane resin composition can harden itself, even if no crosslinking agent exists.

The curable urethane resin composition may contain a crosslinking agent or a crosslinking catalyst.

As the crosslinking agent, same kind of polyols such as polyether polyols, polyester polyols, vinyl-(meth) acrylic acid ester-copolymerized polyols, etc., all of which can form the urethane prepolymer as mentioned above, are exemplified. Further, polyols such as aminopolyether polyols, etc., which are produced through addition of alkylene oxides to lower alkylamines, can also be exemplified. Preferably, the hydroxyl equivalent of such polyols is within the range of 10-1,000.

As crosslinking agents, acid hydrazides such as oxalic acid dihydrazide, succinic acid dihydrazide, adipic acid dihydrazide, isophthalic acid dihydrazide, citric acid trihydrazide, maleic acid dihydrazide, etc.; aminoguanidines such as 1-amino-3-salicyl guanidine, triaminoguanidine, etc.; dicyandiamides such as dicyandiamide, n-butyldicyandiamide, etc.; guanyl ureas such as methylenebis guanyl urea, etc.; guanamines such as acetoguanamine, adipoguanamine, benzoguanamine, phthaloguanamine, etc.; melamines such as hexamethoxymethyl melamine, etc.; hydantoins such as hydantoin, 1-acetyl hydantoin, glycidyl hydantoin, etc.; acid imides such as acetylimide, phthalimide, succinimide, etc.; triazine ring-containing compounds such as cyanuric acid, isocyanuric acid, melamine, methylolmelamine, TGIC (triglycidylisocyanulate), tris(2-hydroxyethyl)isocyanulate, etc. can be exemplified.

At least one kind selected from the above mentioned compounds is preferably used as the crosslinking agent. Especially, aminopolyether polyols, which are addition products of alkylene oxides to lower alkylamines, are more preferable. Aminopolyether polyols having a hydroxyl equivalent of 10-400, which are addition products of alkylene oxides to aliphatic alkyl amines are still more preferable.

The crosslinking agent is preferably added within the range of 0.5-1.2 equivalents with respect to one —NCO group equivalent in the urethane prepolymer.

When the polyols mentioned above is used as the crosslinking agent, acid hydrazides such as adipic acid dihydrazide, sebacic acid dihydrazide, etc.; dicyandiamides such as n-butyldicyanediamide, dicyanediamide, etc.; melamines such as hexamethoxymethyl melamine, etc.; acidimides such as succinimide, etc.; triazine ring-containing compounds such as isocyanuric acid, etc.; adducts of novolak phenols to either one of diethylenetriamine, triethylenetetramine and hexamethylenediamine; all of which act as a crosslinking aid or a potential curative agent, are preferably added into the urethane resin composition in order to improve curing characteristics. More specifically, AMICURE (registered trademark) PN-23, MY-24, PN-D, MY-D, PN-H (all of them are produced by Ajinomoto Co. Inc.); FUJICURE (registered trademark) FXE-1000, FXR-1030 (all of them are produced by Fujikasei Kogyo Co., Ltd.); adipic acid dihydrazide (ADH), strearic acid dihydrazide (SDH) (all of them are produced by Nippon Hydrazine Co., Ltd.) can be exemplified. Aminoguanidines, guanyl ureas, guanamines or hydantoins may be used as the crosslinking aid. Such crosslinking aids are added solely or in a mixture of two or more of them. The total amount of the crosslinking aid to be added is preferably within the range of 0.2-1.2 equivalents with respect to one equivalent of —NCO group in the urethane prepolymer.

These crosslinking agents and aids are optionally selected in view of storage stability, curing characteristics, etc. of the curable urethane resin composition, or such properties as the melting point, the glass transition temperature (Tg), etc. of the cured coated layer.

The curable urethane resin composition may contain an urethanization catalyst as the crosslinking catalyst, for example, a tin-containing catalyst such as dibutyltin dilaurate, dibutyltin dimaleate, monobutyltin octoate, etc., because crosslinking and curing characteristics are further improved. The crosslinking catalyst may be added in advance into the curable urethane resin composition or the heat-curable plastisol composition.

The heat-curable plastisol composition for coating of the present invention comprises the curable urethane resin composition and fine powder of an acrylic resin.

The heat-curable plastisol composition preferably contains 5-250 parts by weight of the curable urethane resin composition with respect to 100 parts by weight of the fine powder of the acrylic resin. 80-0.5 parts by weight of a blocked urethane prepolymer may be contained with respect to 100 parts by weight of the fine powder of the acrylic resin.

The fine powder of the acrylic resin is, for example, a copolymerized acrylic resin made from (meth)acrylic esters and unsaturated group-containing carboxylic acids, esters thereof or vinyl ether, or acrylic resins polymerized from (meth)acrylic esters. These acrylic resins preferably have an average molecular weight of 50,000-4,000,000 and a glass transition temperature (Tg) of 20-120 degrees centigrade. The fine powder has preferably a particle size of 100 micrometer at maximum, more preferably, not more than 10 micrometer. When the polymer in the curable urethane resin composition is an acrylic resin, the fine powder can be made from the same or different kind of material as that of the polymer.

The heat curable plastisol composition for coating may contain a curing catalyst, plasticizer, solvent, filler, stabilizer, flame retardant, foaming agent, etc. The curing catalysts are preferably organic tin compounds such as dibutyltin laurate, dibutyltin dimaleate, monobutyltin octoate, etc., all of which are usually used as urethanization catalysts; or tertiary amines such as triethylamine, triethylenediamine, dimethylbenzylamine, etc., because these catalysts further improve crosslinking and curing characteristics. These additives may be added in advance in the curable urethane resin composition.

When the heat curable prastisol composition is applied and heated, the blocked urethane prepolymer in the composition is thermally split into urethane prepolymer and blocking agent. Terminal isocyanate groups of the urethane prepolymers are linked to each other through the crosslinking agent. This reaction is repeated to at last form a network-like polymerized coated layer. Flexibility, elongation characteristics, tensile strength and adhesiveness of the coated layer show the same or higher level of that of a coated layer formed from a polyvinyl chloride resin-containing plastisol composition.

### EXAMPLE

Hereunder, the curable urethane resin composition and the plastisol composition which contains the curable urethane resin composition and gives a coated layer of the present invention will be explained in detail.

Examples of the curable urethane resin composition and the plastisol composition are prepared as follows.

Propylene oxide adduct of glycerin as a polyether polyol, which is used as the polyol, 2,4-tolylene diisocyanate as the organic isocyanate and (meth)acrylic ester polymer, which is an acrylic resin used as the polymer, are charged and stirred at a temperature of 40-120 degrees centigrade, preferably 40-90 degrees centigrade, obtaining an urethane prepolymer having a remaining isocyanate group at its end. In order to accelerate the reaction, the organic tin compound such as dibutyltin dilaurate, monobutyltin octoate, etc. or the tertiary amine such as triethylamine, triethylenediamine, dimethylbenzylamine, etc. can be used.

To the urethane prepolymer, methylethylketoxime as the blocking agent, and propylene oxide adduct of ethylenediamine as the crosslinking agent, are added and stirred at the same temperature. 50-100% of the terminal isocyanate group of the urethane prepolymer is reacted with the blocking agent, giving the blocked urethane prepolymer. The blocked urethane prepolymer may have its terminal isocyanate group all protected by the blocking agent. The terminal isocyanate group may be partially blocked by the blocking agent or partially crosslinked in advance by the crosslinking agent. In the following chemical equation [I], an example of the formation of the blocked urethane prepolymer (3) is shown in which all terminal isocyanate groups of the urethane prepolymer (1) are protected by methylethylketoxime (2).

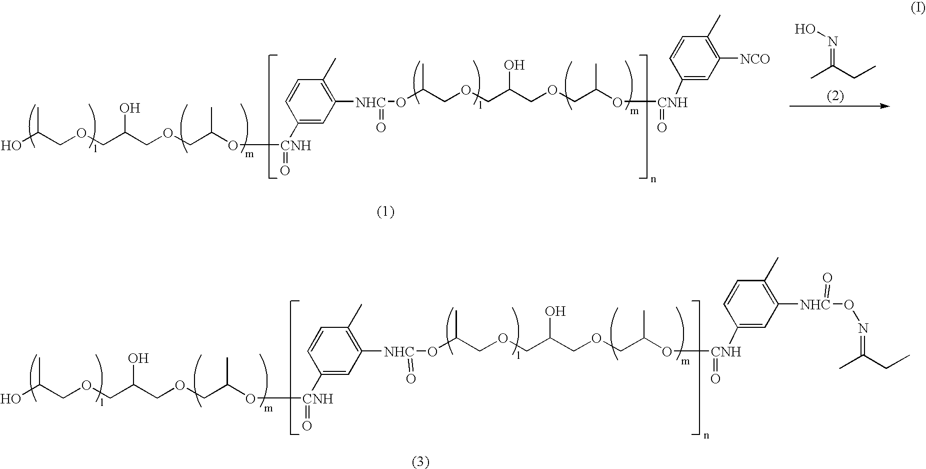

Through this reaction, the curable urethane resin composition containing the acrylic resin uniformly dispersed in the blocked urethane prepolymer is obtained.

Into the curable urethane resin composition, fine powder of an acrylic resin, plasticizer, and calcium carbonate as the filler are admixed. When a compound which acts as a crosslinking agent or a crosslinking aid such as an acid hydrazide, a dicyandiamide, a melamine, an acid imide and a triazine ring-containing compound is added solely or in a mixture of two or more of them and mixed uniformly, a heat curable plastisol composition having excellent curing characteristics and giving higher crosslinking density can be obtained.

The heat curable plastisol composition for coating is applied and heated at about 110-130 degrees centigrade for about 30 min. Then, as shown in the following chemical equation [II], the blocked urethane prepolymer (3) is decomposed and methylethylketoxime is thermally split, regenerating the terminal isocyanate group in the urethane prepolymer (1).

A crosslinking agent (4) named by N-oxypropylene-ethylenediamine, which is a propyleneoxide adduct of ethylenediamine as an aminopolyether polyol, reacts with the terminal isocyanate groups to crosslink, yielding a partially crosslinked compound (5).

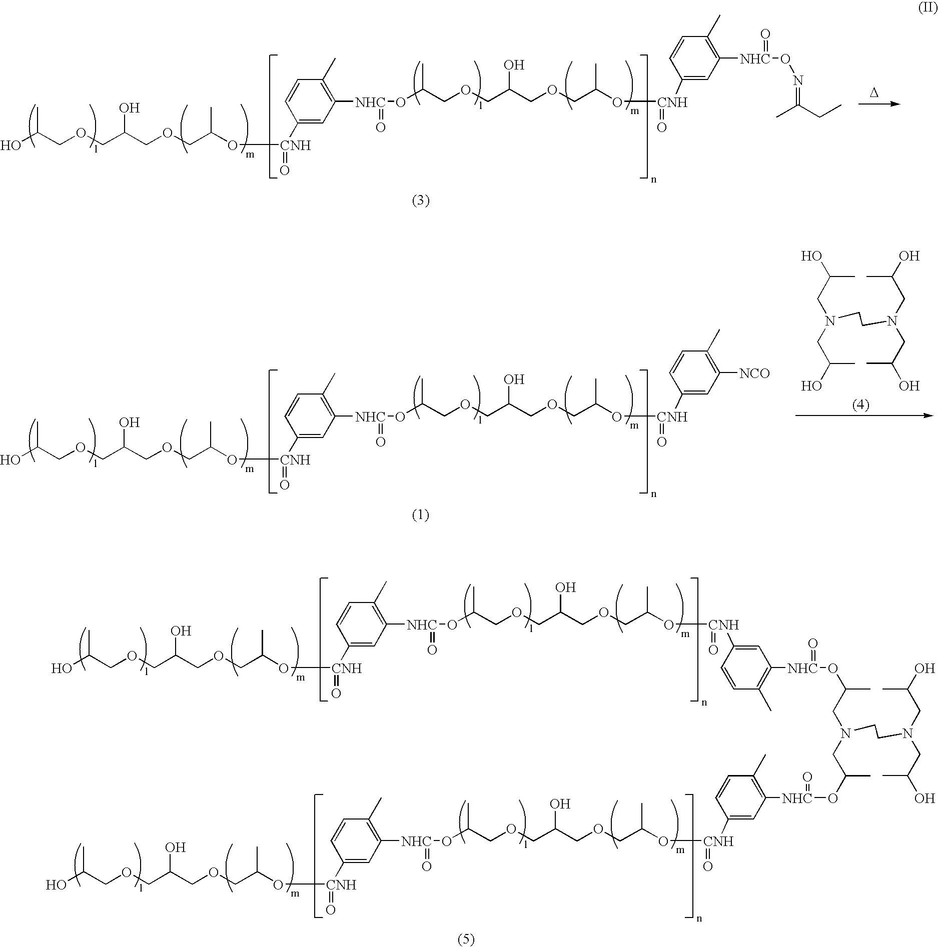

With respect to the crosslinked compound (5), crosslinking reaction further occurs sequentially, leading the compound (5) to at last a stable network-like polymer, while containing the acrylic polymer therein, and forming a coated layer excellent in flexibility, elongation characteristics, tensile strength, flame resistance, adhesiveness, etc. When the aforementioned crosslinking agents such as adipic acid dihydrazide, isocyanuric acid are used, crosslinking is formed alike.

The curable urethane resin composition can also be prepared as follows.

Propylene oxide adduct of glycerine and an unsaturated compound such as (meth)acrylic ester are charged, synthesizing an acrylic polymer under nitrogen gas at 40-120 degrees centigrade using AIBN (2,2′-azobisisobutyronitrile) as a polymerization initiator. Then 2,4-tolylene diisocyanate is charged and stirred at 40-120 degrees centigrade, preferably 40-90 degrees centigrade, obtaining the urethane prepolymer having a remaining isocyanate group at its end. As is stated above, an organic tin compound or a tertiary amine may be used as a catalyst to accelerate the reaction. Then the blocking agent such as methylethylketoxime and the crosslinking agent such as propyleneoxide adduct of ethylenediamine, acid hydrazide, dicyandiamide, melamine, acid imide, a triazine ring-containing compound, etc. are added and stirred at the same temperature, producing the blocked urethane prepolymer and giving the curable urethane resin composition. Hereunder, in preparatory Examples 1-12, preparative procedures of the curable urethane resin composition of the present invention are shown, and in Comparative Examples 1-4, preparative procedures of a curable urethane resin composition, which is outside the scope of the present invention, are shown.

### Preparatory Example 1

Into a flask equipped with a stirrer, a thermometer and a nitrogen gas inlet, 174 parts by weight of 2,4-tolylene diisocyanate, 1,000 parts by weight of a polyether polyol having an average molecular weight of 3,000 prepared through an addition of 50 equivalents of propylene oxide to one equivalent of glycerine, 140 parts by weight of an acrylic polymer having an average molecular weight of 200,000 and Tg of 70 degrees centigrade, and 0.3 parts by weight of dibutyltin laurate were charged. The mixture was stirred under nitrogen atmosphere at an inner temperature of 45-90 degrees centigrade and reacted, synthesizing the urethane prepolymer. Next, to the reacted mixture, 78.3 parts by weight (90% equivalent) of methylethylketoxime as a blocking agent was dropped at 35-45 degrees centigrade and reacted to synthesize a blocked urethane prepolymer. To this reacted mixture, 73 parts by weight of an aminopolyether polyol prepared through an addition of 4 equivalent of propylene oxide to one equivalent of ethylenediamine was added and stirred at 50-80 degrees centigrade. Reaction was allowed to continue until the infrared absorption peak at 2260 cm⁻¹ due to isocyanate group was not observed when infrared absorption spectrum of the reaction mixture was measured, obtaining the resin composition containing a partially-crosslinked blocked urethane prepolymer.

### Preparatory Example 2

Into a flask with a stirrer, a thermometer and a nitrogen gas inlet, 1,000 parts by weight of the same polyether polyol, which was used in Preparatory Example 1, having an average molecular weight of 3,000 prepared through an addition of 50 equivalents of propylene oxide to one equivalent of glycerine, 126 parts by weight of methylmethacrylate, 63 parts by weight of n-butylmethacrylate and 126 parts by weight of isobutylmethacrylate were charged, and 0.5 parts by weight of AIBN (2,2′-azoisobutyronitrile) was added to react at 40-120 degrees centigrade under nitrogen, synthesizing an acrylic resin as the polymer. Then 174 parts by weight of 2,4-tolylene diisocyanate, 0.3 parts by weight of dibutyltin dilaurate were further added to react at 40-90 degrees centigrade, synthesizing a urethane prepolymer. Next, 78.3 parts by weight (90% equivalent) of methylethylketoxime was dropped at 40-50 degrees centigrade to react to synthesize a blocked urethane prepolymer. To this reacted mixture, 73 parts by weight of aminopolyether polyol prepared through an addition of 4 equivalents of propylene oxide to ethylene diamine was added and stirred at 50-80 degrees centigrade. Reaction was allowed to continue until the infrared absorption peak at 2260 cm⁻¹ due to isocyanate group was not observed when infrared absorption spectrum of the reaction mixture was measured, obtaining the resin composition containing a partially crosslinked blocked urethane prepolymer.

### Preparatory Example 3

To the urethane prepolymer containing the acrylic resin synthesized in Preparatory Example 1, 87 parts by weight (100% equivalent) of methylethylketoxime was dropped and reacted at 35-45 degrees centigrade. The reaction was allowed to continue until the infrared absorption peak at 2260 cm⁻¹ due to isocyanate group was not observed when infrared absorption spectrum of the reaction mixture was measured. The curable urethane resin composition was obtained by adding 73 parts by weight of an aminopolyether polyol prepared through addition of 4 equivalents of propylene oxide to ethylenediamine to the blocked urethane prepolymer.

### Preparatory Example 4

To the urethane prepolymer containing the acrylic polymer synthesized in preparatory Example 2, 87 parts by weight (100% equivalent) of methylethylketoxime was added and reacted at 35-45 degrees centigrade. The reaction was allowed to continue until the infrared absorption peak at 2260 cm⁻¹ due to isocyanate group was not observed when infrared absorption spectrum of the reaction mixture was measured. The curable urethane resin composition was obtained by adding 73 parts by weight of an aminopolyether polyol prepared through addition of 4 equivalents of propylene oxide to ethylenediamine to the blocked urethane prepolymer.

### Preparatory Example 5

Except that a polyester polyol having an average molecular weight of 3,000 prepared through ring-opening polymerization of delta-valerolactone and glycerine was used, in place of the polyether polyol prepared through addition of propylene oxide to glycerine, the curable urethane resin composition was obtained through the same procedure as described in Preparatory Example 1.

### Preparatory Example 6

Except that the polyester polyol having an average molecular weight of 3,000 prepared through ring-opening polymerization of delta-valerolactone and glycerine was used, in place of the polyether polyol prepared through addition of propylene oxide to glycerine, the curable urethane resin composition was obtained through the same procedure as described in Preparatory Example 2.

### Preparatory Example 7

Except that dicyclohexylamine was used in place of methylethylketoxime, the curable urethane resin composition was obtained through the same procedure as described in Preparatory Example 1.

### Preparatory Example 8

Except that dicyclohexylamine was used in place of methylethylketoxime, the curable urethane resin composition was obtained through the same procedure as described in Preparatory Example 2.

### Preparatory Example 9

Except that a mixture of 2,4′-diphenylmethanediisocyanate and 4,4′-diphenylmethanedisocyanate was used in place of 2,4-tolylenediisocyanate, the curable urethane resin composition was obtained through the same procedure as described in Preparatory Example 1.

### Preparatory Example 10

Except that a mixture of 2,4′-diphenylmethanediisocyanate and 4,4′-diphenylmethanediisocyanate was used in place of 2,4-tolylenedisocyanate, the curable urethane resin composition was obtained through the same procedure as described in Preparatory Example 2.

### Preparatory Example 11

Except that aminopolyether polyol as the crosslinking agent was not used, the curable urethane resin composition was obtained through the same procedure as described in Preparatory Example 3.

### Preparatory Example 12

Except that aminopolyether polyol as the crosslinking agent was not used, the curable urethane resin composition was obtained through the same procedure as described in Preparatory Example 4.

### Comparative Preparatory Example 1

Except that the acrylic polymer used in Preparatory Example 1 was not used, the curable urethane resin composition was obtained through the same procedure as described in Preparatory Example 1.

### Comparative Preparatory Example 2

Except that the acrylic polymer used in Preparatory Example 3 was not used, the curable urethane resin composition was obtained through the same procedure as described in Preparatory Example 3.

### Comparative Preparatory Example 3

Except that the acrylic polymer and aminopolyether polyol as the crosslinking agent used in Preparatory Example 3 were not used, the curable urethane resin composition was prepared through the same procedure as described in Preparatory Example 3.

### Comparative Preparatory Example 4

Except that the acrylic polymer used in Preparatory Example 5 was not used, the curable urethane resin composition was obtained through the same procedure as described in Preparatory Example 5.

### Examples 1-12 and Comparative Examples 1-4

10 parts by weight of the curable urethane resin composition prepared in Preparatory Examples 1-12 and Comparative Preparatory Examples 1-4, 24 parts by weight of ZEON F-340 (trade name by Zeon Corporation) as fine powder of the acrylic resin, 36 parts by weight of diisononylphthalate (DINP) as a plasticizer, 40 parts by weight of CALSEEDS PL-10 (trade name by Konoshima Chemical Co., Ltd) as calcium carbonate of filler, 0.1 parts by weight of S-CAT-1 (trade name by Sankyo Organic Chemical Co., Ltd.), dibutyltin dilaurate (DBTL) as a crosslinking catalyst, 0.2 parts by weight of adipic acid dihydrazide (ADH) as a potentially curative agent were charged into a mixer, kneaded and degassed to produce each heat curable plastisol composition for coating corresponding to Examples 1-12 and each plastisol composition corresponding to Comparative Examples 1-4, respectively.

The heat curable plastisol compositions for coating corresponding to Examples 1-12 and Comparative Examples 1-4 were subjected to a storage stability test. In addition, these plastisol compositions were each applied on a cation coated steel plate, heated and cured. Thus obtained coated layers were subjected to chipping resistance test for measuring an adhesive strength, chipping resistance test after water immersion, elongation test at room temperature and −30 degrees centigrade, blistering test after moisture absorption.

(Storage Stability Test)

Viscosity at 25 degrees centigrade of each heat curable plastisol for coating was measured using BH type viscometer. Next, each plastisol composition was stored for 10 days at 35 degrees centigrade, then viscosity at 25 degrees centigrade was again measured. Assessment of storage stability was carried out by classifying results into two classes, that is when increasing rate of viscosity after storage was less than 30% the result was designated by ◯; when not less than 30%, by X. The results were shown in Table 1.

(Chipping Resistance Test: Adhesion Strength Test)

Each heat curable prastisol composition for coating was applied so as to be a square of 50-100 mm on a side and 0.5 mm thick on a cation coated steel substrate, then heat-treated at 120 degrees centigrade for 30 minutes and then air-dried at room temperature for one day. The thus obtained test piece was tilted at an angle of 60 degree to the horizon, then a nut of 3 mm thick and 6 mm in diameter was dropped onto a circled area of 4 cm in diameter within every 30 seconds. The procedure was repeated until the cation coated surface appeared by peeling, floating or wearing of the coated layer. The total weight of nuts used until the coated surface appeared was regarded as adhesion strength. Assessment of adhesion strength was carried out by classifying results into two classes, that is when adhesive strength was not less than 40 kg, the result was designated by ◯; while less than 40 kg, by X. The results were shown in Table 1.

(Chipping Resistance Test after Water Immersion: Adhesion Strength Test)

Each heat curable plastisol composition for coating was applied on a cationic electrodeposition-coated steel plate having a square of 50-100 mm on a side and 0.5 mm thick, heat-treated at 120 degrees centigrade for 30 minutes and then air-dried at room temperature for one day. The thus obtained samples were immersed into water at 40 degrees centigrade for 14 days. After picked them out and wiped, they were air-dried at a room temperature for one day, obtaining test pieces. Adhesion strength test after water immersion was carried out in the similar way as described in the above mentioned Adhesion Strength Test. Assessment was carried out by classifying results into two classes, that is when adhesion strength was not less than 20 kg, the result was designated by ◯; while less than 20 kg, by X. The results were shown in Table 1.

(Elongation Test at 25 Degrees Centigrade)

Each heat curable plastisol composition for coating was applied so as to be a thickness of 1 mm on a glass plate, then heat-treated at 120 degrees centigrade for 30 minutes and then air-dried at a room temperature for one day, and then punched out to obtain a test piece. Elongation of the test piece was measured under a constant temperature-and-humidity atmosphere at the room temperature using Rheometer (Model: CR-2000D, or CR-300 (by Sun Seientifie Co., Ltd.)). Assessment was carried out by classifying the results into three classes, that is when elongation was not less than 300%, the result was designated by ◯; while elongation was within the range of 250-299%, by Δ; and less than 250%, by X. The results were shown in Table 1.

(Elongation Test at −30 Degrees Centigrade)

Test pieces were prepared according to the same procedure as in Elongation Test at 25 degrees centigrade. Then elongation was measured in an atmosphere at −30 degrees centigrade using the same Rheometer. Elongation was assessed by classifying the results into two classes, that is when elongation is not less than 75%, the result was designated by ◯, while less than 75%, by X. Results were shown in Table 1.

(Blistering Test after Moisture Absorption)

Each heat curable plastisol composition for coating was applied so as to be a square of 50 mm by 100 mm and 0.5 mm thick on a cationic electrodeposition-coated steel plate, obtaining a test piece. The test piece was exposed to an atmosphere at a humidity of 80% and at 30 degrees centigrade for one day and preheated at 110 degrees centigrade for 10 minutes and then heat-treated at 140 degrees centigrade for 30 minutes. The thus obtained coated layer was examined with the naked eyes to determine whether or not foaming or blistering occurred on the surface. Assessment was carried out by classifying the results into two classes, that is when no foaming or blistering was observed, the result was designated by ◯; while foaming or blistering was observed, by X. Results were shown in Table 1.

TABLE 1

| | | | | Example | | | | | | | |
|---|---|---|---|---|---|---|---|---|---|---|---|
| | | | | 1 | 2 | 3 | 4 | 5 | 6 | 7 | 8 |
| Compounding | Urethane | Prep. | 1 | 10 | | | | | | | |
| (parts by weight) | resin | Ex. | 2 | | 10 | | | | | | |
| | composition | | 3 | | | 10 | | | | | |
| | | | 4 | | | | 10 | | | | |
| | | | 5 | | | | | 10 | | | |
| | | | 6 | | | | | | 10 | | |
| | | | 7 | | | | | | | 10 | |
| | | | 8 | | | | | | | | 10 |
| | | | 9 | | | | | | | | |
| | | | 10 | | | | | | | | |
| | | | 11 | | | | | | | | |
| | | | 12 | | | | | | | | |
| | | Comp. | 1 | | | | | | | | |
| | | Prep. | 2 | | | | | | | | |
| | | Ex. | 3 | | | | | | | | |
| | | | 4 | | | | | | | | |
| | Fine | Zeon | | 24 | 24 | 24 | 24 | 24 | 24 | 24 | 24 |
| | powder | F-340 | | | | | | | | | |
| | of acrylic | | | | | | | | | | |
| | resin | | | | | | | | | | |
| | Plasticizer | DINP | | 36 | 36 | 36 | 36 | 36 | 36 | 36 | 36 |
| | Filler | Calseeds | | 40 | 40 | 40 | 40 | 40 | 40 | 40 | 40 |
| | | p110 | | | | | | | | | |
| | Crosslinking | DBTL | | 0.1 | 0.1 | 0.1 | 0.1 | 0.1 | 0.1 | 0.1 | 0.1 |
| | catalyst | | | | | | | | | | |
| | Crosslinking | ADH | | 0.2 | 0.2 | 0.2 | 0.2 | 0.2 | 0.2 | 0.2 | 0.2 |
| | aid | | | | | | | | | | |
| Physical | Storage | Viscosity | | 18 | 18 | 22 | 23 | 25 | 28 | 28 | 25 |
| Properties | stability | increase | | | | | | | | | |
| | | (%) | | | | | | | | | |
| | | Evaluation | | ◯ | ◯ | ◯ | ◯ | ◯ | ◯ | ◯ | ◯ |
| | Chipping | Total | | 54 | 62 | 48 | 50 | 44 | 48 | 42 | 44 |
| | | weight of | | | | | | | | | |
| | | nuts (kg) | | | | | | | | | |
| | | Evaluation | | ◯ | ◯ | ◯ | ◯ | ◯ | ◯ | ◯ | ◯ |
| | Chipping | Total | | 36 | 37 | 28 | 30 | 26 | 26 | 23 | 26 |
| | after | weight of | | | | | | | | | |
| | immersion | nuts (kg) | | | | | | | | | |
| | | Evaluation | | ◯ | ◯ | ◯ | ◯ | ◯ | ◯ | ◯ | ◯ |
| | Elongation | Elongation | | 309 | 305 | 313 | 317 | 290 | 294 | 300 | 303 |
| | at | (%) | | | | | | | | | |
| | 25 deg. C. | Evaluation | | ◯ | ◯ | ◯ | ◯ | Δ | Δ | ◯ | ◯ |
| | Elongation | Elongation | | 106 | 109 | 110 | 116 | 89 | 93 | 85 | 91 |
| | at | (%) | | | | | | | | | |
| | −30 deg. C. | Evaluation | | ◯ | ◯ | ◯ | ◯ | ◯ | ◯ | ◯ | ◯ |
| | Blistering | Blistering | | No | No | No | No | No | No | No | No |
| | | Evaluation | | ◯ | ◯ | ◯ | ◯ | ◯ | ◯ | ◯ | ◯ |
| | | | | | | | | Comp. | | | |
| | | | | Example | | | | Example | | | |
| | | | | 9 | 10 | 11 | 12 | 1 | 2 | 3 | 4 |
| Compounding | Urethane | Prep. | 1 | | | | | | | | |
| (parts by weight) | resin | Ex. | 2 | | | | | | | | |
| | composition | | 3 | | | | | | | | |
| | | | 4 | | | | | | | | |
| | | | 5 | | | | | | | | |
| | | | 6 | | | | | | | | |
| | | | 7 | | | | | | | | |
| | | | 8 | | | | | | | | |
| | | | 9 | 10 | | | | | | | |
| | | | 10 | | 10 | | | | | | |
| | | | 11 | | | 10 | | | | | |
| | | | 12 | | | | 10 | | | | |
| | | Comp. | 1 | | | | | 10 | | | |
| | | Prep. | 2 | | | | | | 10 | | |
| | | Ex. | 3 | | | | | | | 10 | |
| | | | 4 | | | | | | | | 10 |

| | | | | | | | | | | |
|---|---|---|---|---|---|---|---|---|---|---|
| | Fine | Zeon | 24 | 24 | 24 | 24 | 24 | 24 | 24 | 24 |
| | powder | F-340 | | | | | | | | |
| | of acrylic | | | | | | | | | |
| | resin | | | | | | | | | |
| | Plasticizer | DINP | 36 | 36 | 36 | 36 | 36 | 36 | 36 | 36 |
| | Filler | Calseeds | 40 | 40 | 40 | 40 | 40 | 40 | 40 | 40 |
| | | p110 | | | | | | | | |
| | Crosslinking | DBTL | 0.1 | 0.1 | 0.1 | 0.1 | 0.1 | 0.1 | 0.1 | 0.1 |
| | catalyst | | | | | | | | | |
| | Crosslinking | ADH | 0.2 | 0.2 | 0.2 | 0.2 | 0.2 | 0.2 | 0.2 | 0.2 |
| | aid | | | | | | | | | |
| Physical | Storage | Viscosity | 20 | 21 | 12 | 10 | 22 | 22 | 18 | 25 |
| Properties | stability | increase | | | | | | | | |
| | | (%) | | | | | | | | |
| | | Evaluation | ◯ | ◯ | ◯ | ◯ | ◯ | ◯ | ◯ | ◯ |
| | Chipping | Total | 51 | 55 | 41 | 40 | 40 | 34 | 14 | 31 |
| | | weight of | | | | | | | | |
| | | nuts (kg) | | | | | | | | |
| | | Evaluation | ◯ | ◯ | ◯ | ◯ | ◯ | X | X | X |
| | Chipping | Total | 29 | 34 | 26 | 24 | 25 | 19 | 4 | 16 |
| | after | weight of | | | | | | | | |
| | immersion | nuts (kg) | | | | | | | | |
| | | Evaluation | ◯ | ◯ | ◯ | ◯ | ◯ | X | X | X |
| | Elongation | Elongation | 300 | 300 | 280 | 270 | 220 | 220 | 210 | 220 |
| | at | (%) | | | | | | | | |
| | 25 deg. C. | Evaluation | ◯ | ◯ | Δ | Δ | X | X | X | X |
| | Elongation | Elongation | 101 | 100 | 78 | 81 | 60 | 60 | 70 | 61 |
| | at | (%) | | | | | | | | |
| | −30 deg. C. | Evaluation | ◯ | ◯ | ◯ | ◯ | X | X | X | X |
| | Blistering | Blistering | No | No | No | No | No | No | No | Yes |
| | | Evaluation | ◯ | ◯ | ◯ | ◯ | ◯ | ◯ | ◯ | X |

From Table 1, the heat curable plastisol composition for coating of Examples 1-12 all show an excellent storage stability, and the heated and cured coating layers thereof all have an excellent adhesive strength, elongation characteristics and blistering after moisture absorption. On the contrary, the heated and cured coating layer of the plastisol composition of Comparative Examples 1-4 all show poor adhesion strength, elongation characteristics and blistering after moisture absorption.

Next, examples of other curable urethane resin compositions of the present invention will be shown in Preparatory Examples 13-20. Examples of other curable urethane resin compositions outside the scope of the present invention will be shown in Comparative Preparatory Examples 5-10 hereunder.

### Preparatory Example 13

Into a flask equipped with a stirrer, a thermometer and a nitrogen gas inlet, 174 parts by weight of 2,4-tolylene diisocyanate, 1,000 parts by weight of polyether polyol having an average molecular weight of 3,000 prepared through addition of 50 equivalents of propylene oxide to one equivalent of glycerine, 140 parts by weight of an acrylic resin having an average molecular weight of 200,000, 0.3 parts by weight of dibutyltin dilaurate were charged under nitrogen gas and stirred to react at internal temperature of 40-90 degrees centigrade, synthesizing an urethane prepolymer. Next, to the thus obtained mixture, 78.3 parts by weight (90% equivalent) of methylethyl ketoxime, a blocking agent, was dropped to react at 40-50 degrees centigrade, synthesizing the blocked urethane prepolymer. Then to the reacted mixture, 73 parts by weight of aminopolyether polyol prepared through addition of 4 equivalents of propylene oxide to one equivalent of ethylenediamine was added and stirred at 50-80 degrees centigrade. The reaction was allowed to continue until the infrared absorption peak of 2260 cm⁻¹ due to isocyanate group was not observed when infrared absorption spectrum of the reaction mixture was measured, obtaining the resin composition containing a partially-crosslinked blocked urethane prepolymer.

### Preparatory Example 14

Into a flask equipped with a stirrer, a thermometer and a nitrogen gas inlet, 1,000 parts by weight of the same polyether polyol having an average molecular weight of 3,000 prepared through addition of 50 equivalents of propylene oxide to one equivalent of glycerine as described in Preparatory Example 13, 126 parts by weight of methylmethacrylate, 63 parts by weight of n-butylmethacrylate, 126 parts by weight of isobutylmethacrylate were charged and 0.5 parts by weight of AIBN (2,2′-azoisobutyronitrile) was added to react at 40-120 degrees centigrade under nitrogen gas, synthesizing an acrylic resin as the polymer. Then 174 parts by weight of 2,4-tolylene diisocyanate and 0.3 parts by weight of dibutyltin dilaurate were charged to react at 40-90 degrees centigrade, synthesizing an urethane prepolymer. Next, 78.3 parts by weight (90% equivalent) of methylethylketoxime was dropped to react at 40-50 degrees centigrade, synthesizing the blocked urethane prepolymer. To the thus obtained reaction mixture, 73 parts by weight of aminopolyether polyol prepared through addition of 4 equivalents of propylene oxide to ethylenediamine was added and stirred at 50-80 degrees centigrade. The reaction was allowed to continue until the infrared absorption peak of 2260 cm⁻¹ due to isocyanate group was not observed when infrared absorption spectrum of the reaction mixture was measured, obtaining the resin composition containing a partially-crosslinked blocked urethane prepolymer.

### Preparatory Example 15

Except that 172.2 parts by weight (95% equivalent) of dicyclohexylamine was dropped in place of methylethylketoxime used in Preparatory Example 13, to react at 40-45 degrees centigrade and synthesize the blocked urethane prepolymer, the curable urethane resin composition was obtained through the same procedure as described in Preparatory Example 13.

### Preparatory Example 16

Except that polyester polyol having an average molecular weight of 3,000 prepared through ring-opening polymerization of glycerine and delta-valerolactone was used in place of polyether polyol prepared through addition of propylene oxide to glycerine used in Preparatory Example 13, the curable urethane resin composition was obtained through the same procedure as described in Preparatory Example 13.

### Preparatory Example 17

Except that 172.2 parts (95% equivalent) by weight of dicyclohexylamine was added in place of methylethylketoxime in Preparatory Example 13, to react at 40-45 degrees centigrade and synthesize the blocked urethane prepolymer, the curable urethane resin composition was obtained through the same procedure as described in Preparatory Example 13.

### Preparatory Example 18

Except that a mixture of 2,4′-diphenylmethane diisocyanate and 4,4′-diphenylmethane diisocyanate was used in place of 2,4-tolylenediisocyanate used in Preparatory Example 13, the curable urethane resin composition was obtained through the same procedure as described in Preparatory Example 13.

### Preparatory Example 19

Except that 172.2 parts by weight (95% equivalent) of dicyclohexylamine was added in place of methylethylketoxime used in Preparatory Example 18, to react at 40-45 degrees centigrade and synthesize the blocked urethane prepolymer, the curable urethane resin composition was obtained through the same procedure as described in Preparatory Example 18.

### Preparatory Example 20

Except that a novolak type phenol resin (average molecular weight: 200-4,000) was used in place of the acrylic resin used in Preparatory Example 13, the curable urethane resin composition was obtained through the same procedure as described in Preparatory Example 13.

### Preparatory Example 21

Except that an epoxy resin (average molecular weight: 400-2,500) was used in place of the acrylic resin used in Preparatory Example 13, and a polyfunctional polyol (polyglycerine: average molecular weight 1,300-1,500) was used in place of aminopolyether polyol used in Preparatory Example 13, the urethane resin composition was obtained through the same procedure as described in Preparatory Example 13.

The curable urethane resin compositions obtained in Preparatory Examples 13-21 were evaluated as an urethane resin composition by adding as shown in Table 2, adipic acid dihydrazide (ADH) as acid hydrazides, dicyandiamides, hexamethoxymethylmelamine as melamines, succinimide as acid imides and isocyanuric acid as triazine ring-containing compounds, solely or a mixture of two or more of them, and also by adding dibutyltin dilaurate as crosslinking catalyst.

### Comparative Preparatory Example 5

Except that the acrylic resin used in Preparatory Example 13 was not used, the urethane resin composition was obtained through the same procedure as described in Preparatory Example 13.

### Comparative Preparatory Example 6

Except that aminopolyether polyol prepared through addition of 4 equivalents of propylene oxide to one equivalent of ethylenediamine used in Preparatory Example 13 was not used, the urethane resin composition was obtained through the same procedure as described in Preparatory Example 13.

### Comparative Preparatory Example 7

The urethane resin composition in Comparative Preparatory Example 7 did not contain the crosslinking aid added to the curable urethane resin composition in Preparatory Example 13.

### Comparative Preparatory Example 8

The urethane resin composition in Comparative Preparatory Example 8 did not contain the curing catalyst (dibutyltin dilaurate) added to the curable urethane resin composition in Preparatory example 13.

### Comparative Preparatory Example 9

The urethane resin composition in Comparative Preparatory Example 9 was obtained, as shown in Table 2, by adding adipic acid dihydrazide as a crosslinking aid to the urethane resin composition obtained in Comparative Preparatory Example 6 and did not contain aminopolyether polyol.

### Comparative Preparatory Example 10

The urethane resin composition in Comparative Preparatory Example 10 did not contain the curing catalyst (dibutyltin dilaurate) to be added into the urethane resin composition which did not contain aminopolyether polyol obtained in Preparatory Example 6.

### Examples 13-21 and Comparative Examples 5-10

15 parts by weight of curable urethane resin composition obtained in Preparatory Examples 13-21 or urethane resin composition obtained in Comparative Preparatory Examples 5-10, 24 parts by weight of core/shell type fine powder of an acrylic resin having an average molecular weight of 700,000 and an average particle size of 0.5 micro meter, 35 parts by weight of diisononylphtalate (DINP) as the plasticizer, 26 parts by weight of NEOLIGHT SP (trade name, produced by Takehara Kagaku Kogyo Co., Ltd), calcium carbonate as a filler, were charged into a mixer, mixed for 30 minutes and degassed, obtaining heat curable plastisol compositions for coating of each Examples 13-21 and plastisol compositions of each Comparative Examples 5-10, respectively.

Plastisol Compositions of Examples 13-21 and Comparative examples 5-10 were subjected to storage stability test. These plastisol compositions were applied on a cationic electrodeposition-coated steel plate substrate, heated and cured, forming coated layers. The coated layers were subjected to chipping resistance test, chipping resistance test after water immersion, adhesion shearing test and blistering test after moisture absorption.

(Storage Stability Test)

Viscosity at 25 degrees centigrade of each plastisol composition of Examples 13-21 and Comparative Examples 5-10 was measured using BH type viscometer. Next, each plastisol was stored for 10 days at 40 degrees centigrade, then viscosity at 25 degrees centigrade was again measured. Storage stability was assessed by grouping the results into two classes, that is when increasing rate of viscosity after storage was less than 30%, the result was designated by ◯; when not less than 30%, by X. Results are shown in Table 2.

(Chipping Resistance Test: Adhesion Strength Test)

Each plastisol composition was applied so as to be a square of 50-100 mm on a side and 0.4 mm thick after drying on a cationic electrodeposition-coated steel plate substrate, heat-treated at 120 degrees centigrade for 30 minutes and then air-dried at room temperature for one day, obtaining a test piece. The test piece was tilted at 60 degree to the horizon and a pipe having 20 mm in inner diameter and 2 m long was vertically mounted on the coating layer. Dropping of a M-4 nut (Japanese Industrial Standard) from the upper end of the pipe was continued until the steel plate substrate appeared, measuring the total weight of the nuts used. Chipping resistance was assessed by grouping the results into two classes, that is when the total weight is not less than 35 kg, the result was designated by ◯; when less than 35 kg, by X. Results are shown in Table 2.

(Chipping Resistance Test after Water Immersion: Adhesion Strength Test)

Test pieces of each plastisol composition were prepared in the same manner as described in the chipping resistance test and air-dried at room temperature for one day. These test pieces were immersed into water at 40 degrees centigrade for 14 days, and picked out and wiped, and then air-dried at room temperature for one day. Chipping resistance test after water immersion was carried out in the same manner as described in the above mentioned chipping resistance test, measuring the total weight of nuts used until the steel plate substrate appeared. Chipping resistance was assessed by grouping the results into two classes, that is when the total weight is not less than 20 kg, the result was designated by ◯; when less than 20 kg, by X. Results are shown in Table 2.

(Adhesion Shearing Test)

Each plastisol composition was applied on an edge portions of two cationic electrodeposition-coated steel plates having 5 mm width, and a spacer was inserted so as to make the volume of coated layer become 25 mm×25 mm×3 mm thick, then heat-treated at 130 degrees sentigrade for 30 minutes, and then air-dried at room temperature for one day, obtaining a test piece. The thus obtained test piece was attached to both ends of a tensile shear tester and stretched at a stretching speed of 50 mm/min. Tensile strength was measured, and condition of fracture surface was observed for determining whether the fracture surface was cohesive failure (CF) or interfacial failure (AF). Values in the interfacial failure box indicate the ratio of area of adhesive failure surface in the bonding area of 25 mm×25 mm. Results are shown in Table 2.

(Blistering Test after Moisture Absorption)

Each plastisol composition was applied so as to be a square of 50-100 mm on a side and 0.4 mm thick after drying, exposed to an atmosphere at a humidity of 80% and at 30 degrees centigrade for one day, preheated at 110 degrees centigrade for 10 minutes, and then heat-treated at 140 degrees centigrade for 30 minutes. The surface of the resulted coated layer was examined whether or not foaming or blistering occurred on the surface. Blistering was assessed by grouping results into two classes, that is when there was no foaming or blistering, it was designated by ◯, when foaming or blistering was observed, by X. Results are shown in Table 2.

TABLE 2

| | | | | Example | | | | | | | |
|---|---|---|---|---|---|---|---|---|---|---|---|
| | | | | 13 | 14 | 15 | 16 | 17 | 18 | 19 | 20 |
| Compounding | Urethane | Prep. | 13 | 15 | | | | | | | |
| (parts by weight) | resin | Ex. | 14 | | 15 | | | | | | |
| | composition | | 15 | | | 15 | | | | | |
| | | | 16 | | | | 15 | | | | |
| | | | 17 | | | | | 15 | | | |
| | | | 18 | | | | | | 15 | | |
| | | | 19 | | | | | | | 15 | |
| | | | 20 | | | | | | | | 15 |
| | | | 21 | | | | | | | | |
| | | Comp. | 5 | | | | | | | | |
| | | Prep. | 6 | | | | | | | | |
| | | Ex. | 7 | | | | | | | | |
| | | | 8 | | | | | | | | |
| | | | 9 | | | | | | | | |
| | | | 10 | | | | | | | | |

| | | | | | | | | | | |
|---|---|---|---|---|---|---|---|---|---|---|
| | | Polymer | Add | Add | Add | Add | Add | Add | Add | Add |
| | | (acrylic resin) | | | | | | | | |
| | | Crosslinking | Add | Add | Add | Add | Add | Add | Add | Add |
| | | agent | | | | | | | | |
| | | (aminopoly- | | | | | | | | |
| | | ether polyol) | | | | | | | | |
| | Fine | Zeon | 24 | 24 | 24 | 24 | 24 | 24 | 24 | 24 |
| | powder | F-340 | | | | | | | | |
| | of acrylic | | | | | | | | | |
| | resin | | | | | | | | | |
| | Plasticizer | DINP | 35 | 35 | 35 | 35 | 35 | 35 | 35 | 35 |
| | Filler | Neolight SP | 26 | 26 | 26 | 26 | 26 | 26 | 26 | 26 |
| | Crosslinking | ADH | | 0.1 | 0.2 | 0.2 | 0.2 | 0.1 | 0.2 | 0.2 |
| | aid | dicyanamide | | | 0.3 | | | | 0.3 | |
| | | Hexamethoxy | | | | 0.2 | | | | 0.3 |
| | | methyl- | | | | | | | | |
| | | melamine | | | | | | | | |
| | | Succinimido | | | | | 0.4 | | | |
| | | Isocyanuric | 0.3 | 0.3 | | | | 0.3 | | |
| | | acid | | | | | | | | |
| | Crosslinking | DBTL | 0.03 | 0.03 | 0.03 | 0.03 | 0.03 | 0.03 | 0.03 | 0.03 |
| | catalyst | | | | | | | | | |
| Physical | Storage | Evaluation | ◯ | ◯ | ◯ | ◯ | ◯ | ◯ | ◯ | ◯ |
| Properties | stability | | | | | | | | | |
| | Chipping | Total weight | 40 | 61 | 58 | 53 | 49 | 58 | 55 | 53 |
| | | of nuts (Kg) | | | | | | | | |
| | | Evaluation | ◯ | ◯ | ◯ | ◯ | ◯ | ◯ | ◯ | ◯ |
| | Chipping | Total weight | 23 | 34 | 30 | 28 | 23 | 32 | 31 | 30 |
| | after | of nuts (Kg) | | | | | | | | |
| | immersion | Evaluation | ◯ | ◯ | ◯ | ◯ | ◯ | ◯ | ◯ | ◯ |
| | Adhesion | Condition | CF | CF | CF | CF | CF | CF | CF | CF |
| | Shearing | of fracture | | | | | | | | |
| | Test | surface | | | | | | | | |
| | | Ratio of area | 0 | 0 | 0 | 0 | 0 | 0 | 0 | 0 |
| | | of adhesive | | | | | | | | |
| | | failure | | | | | | | | |
| | | surface (%) | | | | | | | | |
| | Blistering | Blistering | No | No | No | No | No | No | No | No |
| | | Evaluation | ◯ | ◯ | ◯ | ◯ | ◯ | ◯ | ◯ | ◯ |

| | | | | Example | Comparative Example | | | | | |
|---|---|---|---|---|---|---|---|---|---|---|
| | | | | 21 | 5 | 6 | 7 | 8 | 9 | 10 |
| Compounding | Urethane | Prep. | 13 | | | | | | | |
| (parts by weight) | resin | Ex. | 14 | | | | | | | |
| | composition | | 15 | | | | | | | |
| | | | 16 | | | | | | | |
| | | | 17 | | | | | | | |
| | | | 18 | | | | | | | |
| | | | 19 | | | | | | | |
| | | | 20 | | | | | | | |
| | | | 21 | 15 | | | | | | |
| | | Comp. | 5 | | 15 | | | | | |
| | | Prep. | 6 | | | 15 | | | | |
| | | Ex. | 7 | | | | 15 | | | |
| | | | 8 | | | | | 15 | | |
| | | | 9 | | | | | | 15 | |
| | | | 10 | | | | | | | 15 |

| | | | | | | | | | |
|---|---|---|---|---|---|---|---|---|---|
| | | Polymer | Add | None | Add | Add | Add | Add | Add |
| | | (acrylic resin) | | | | | | | |
| | | Crosslinking | Add | Add | None | Add | Add | None | None |
| | | agent | | | | | | | |
| | | (aminopoly- | | | | | | | |
| | | ether polyol) | | | | | | | |
| | Fine | Zeon | 24 | 24 | 24 | 24 | 24 | 24 | 24 |
| | powder | F-340 | | | | | | | |
| | of acrylic | | | | | | | | |
| | resin | | | | | | | | |
| | Plasticizer | DINP | 35 | 35 | 35 | 35 | 35 | 35 | 35 |
| | Filler | Neolight SP | 26 | 26 | 26 | 26 | 26 | 26 | 26 |
| | Crosslinking | ADH | 0.2 | | | | | 0.5 | |
| | aid | dicyanamide | | | | | | | |
| | | Hexamethoxy | | | | | | | |
| | | methyl- | | | | | | | |
| | | melamine | | | | | | | |
| | | Succinimido | | | | | | | |
| | | Isocyanuric | | 0.3 | 0.3 | | 0.3 | 0.3 | 0.3 |
| | | acid | | | | | | | |
| | Crosslinking | DBTL | 0.03 | 0.03 | 0.03 | 0.03 | | 0.03 | |
| | catalyst | | | | | | | | |
| Physical | Storage | Evaluation | ◯ | ◯ | ◯ | ◯ | ◯ | ◯ | ◯ |
| Properties | stability | | | | | | | | |
| | Chipping | Total weight | 56 | 38 | Non- | 35 | Non- | 18 | Non- |
| | | of nuts (Kg) | | | curable | | curable | | curable |
| | | Evaluation | ◯ | ◯ | | ◯ | | X | |
| | Chipping | Total weight | 28 | 14 | | 21 | | 6 | |
| | after | of nuts (Kg) | | | | | | | |
| | immersion | Evaluation | ◯ | X | | ◯ | | X | |
| | Adhesion | Condition | CF | CF | | CF | | AF | |
| | Shearing | of fracture | | | | | | | |
| | Test | surface | | | | | | | |
| | | Ratio of area | 0 | 4 | | 0 | | 67 | |
| | | of adhesive | | | | | | | |
| | | failure | | | | | | | |
| | | surface (%) | | | | | | | |
| | Blistering | Blistering | No | Yes | | Little | | Yes | |
| | | Evaluation | ◯ | X | | X | | X | |

As shown in table 2, the plastisol composition of Examples 13-21 were excellent in storage stability and the heated and cured coated layers thereof were excellent in adhesiveness, elongation characteristics and blistering after moisture absorption. On the contrary, as shown in Comparative Examples 6, 8 and 10, curability was so poor that evaluation of solid state properties could not be carried out. In Comparative Examples 5, 7 and 9, curability was not so bad but blistering was observed. In Comparative Example 9, chipping resistance after water immersion was very poor.

### INDUSTRIAL APPLICABILITY

As precisely explained above, the curable urethane resin composition of the present invention can be used for heat curable plastisol composition for coating. Terminal isocyanate groups of the urethane prepolymer crosslink to each other to form a network-like polymer, in which the acrylic polymer is contained.

Therefore, the heat curable plastisol composition comprising the curable urethane resin composition and the fine powder of the acrylic resin can form a coated layer firmly adhering to a coated metal surface, especially to a cationic electrodeposition-coated surface, with a heat treatment at a comparatively lower temperature for a short period of time. Furthermore, the coated layer is excellent in flexibility, elongation characteristics, tensile strength, adhesive strength and durability. In addition, the heat curable plastisol composition for coating has excellent storage stability.

The heat curable plastisol composition for coating can be used, in place of a polyvinylchloride resin-containing plastisol composition, as a chipping resistant paint, coating paint, sealing material, which are used for rust prevention for vehicle bodies, buffers against scattering stone, waterproof of joint sealant, etc in auto industry. Further, conventional coating apparatuses, heat-treating apparatuses, etc. for polyvinylchloride resin-containing plastisol composition can be used as they are for the heat curable plastisol composition for coating of the present invention.

What is claimed is:

1. A curable urethane resin composition comprising:
a blocked urethane prepolymer which is prepared through condensation polymerization of a polyol and an organic isocyanate and has a terminal isocyanate group protected by a blocking agent; and
a polymer dispersed or dissolved in the blocked urethane prepolymer.

2. The curable urethane resin composition according to claim 1, wherein the resin composition further comprising a crosslinking agent which performs crosslinking reaction with the terminal isocyanate group of the urethane prepolymer formed through deblocking of the blocked urethane prepolymer, the crosslinking agent performing the crosslinking reaction to make the prepolymer form a higher molecule while containing the polymer therein.

3. The curable urethane resin composition according to claim 1, wherein a weight ratio of the blocked urethane prepolymer to the polymer is within the range of 100:0.2-60.

4. The curable urethane resin composition according to claim 1, wherein at least one kind of agent selected from oximes, secondary amines, phenols, alcohols and hydroxyl group-containing (meth)acrylic acid esters is used as the blocking agent.

5. The curable urethane resin composition according to claim 1, wherein at least one kind of polyol having a hydroxyl equivalent of 50-2,000 selected from polyether polyols, polyester polyols and vinyl-(meth)acrylic acid ester copolymerized polyols is used as the polyol.

6. The curable urethane resin composition according to claim 1, wherein at least one kind of monomer selected from aromatic diisocyanates, chain aliphatic diisocyanates and cyclic aliphatic diisocyanates; and oligomers thereof; is used as the organic isocyanate.

7. The curable urethane resin composition according to claim 2, wherein at least one kind of agent selected from polyols which has a hydroxyl equivalent of 10-1,000 and is at least either one of aminopolyether polyols prepared through addition of lower alkylamine to alkylene oxide, polyether polyols, polyester polyols and vinyl-(meth)acrylic acid ester copolymerized polyols; acid hydrazides; aminoguanidines; dicyandiamides; guanyl ureas; guanamines; melamines; hydantoins; acid imides and triazine ring-containing compounds: is used as the crosslinking agent.

8. The curable urethane resin composition according to claim 1, wherein the polymer is acrylic resins, phenolic resins, epoxy resins, melamine resins, polyester resins, styrene resins, polyethylene resins, polyamide resins or polyurethane resins.

9. The curable urethane resin composition according to claim 1, wherein the polymer is an acrylic resin of a copolymer of a (meth)acrylic acid ester and at least one kind of vinyl group-containing compound selected from an unsaturated group-containing carboxylic acid, a vinyl ester, a vinyl ether, a maleic acid ester and a fumaric acid ester, or of a polymer of a (meth)acrylic acid ester.

10. The curable urethane resin composition according to claim 1, wherein the polymer has an average molecular weight of 200-4,000,000 and a degree of polymerization of 1-40,000.

11. The curable urethane resin composition according to claim 1, wherein the blocked urethane prepolymer has an average molecular weight of 1,000-500,000.

12. A heat curable plastisol composition for coating comprising:
a curable urethane resin composition comprising a blocked urethane prepolymer which is prepared through condensation-polymerization of a polyol and an organic isocyanate and has a terminal isocyanate group protected by a blocking agent, and a polymer dispersed or dissolved in the blocked urethane prepolymer; and
fine powder of an acrylic resin.

13. The heat curable plastisol composition for coating according to claim 12, wherein the heat curable plastisol composition further comprising a crosslinking agent which performs crosslinking reaction with the terminal isocyanate group of the urethane prepolymer formed through deblocking of the blocked urethane prepolymer, the crosslinking agent performing the crosslinking reaction to make the prepolymer form a higher molecule while containing the polymer therein.

14. The heat curable plastisol composition for coating according to claim 12, wherein the blocked urethane prepolymer has an average molecular weight of 1,000-500,000 and the polymer has an average molecular weight of 200-4,000,000 and a degree of polymerization of 1-40,000.
